(19) United States
(12) Patent Application Publication
(10) Pub. No.: US 2013/0023214 A1
(43) Pub. Date: Jan. 24, 2013

(54) CENTRALIZED DYNAMIC CHANNEL ALLOCATION FOR MEDICAL BODY AREA NETWORKS

(71) Applicants: Dong Wang, Ossining, NY (US); Hongqiang Zhai, Ossining, NY (US); Monisha Ghosh, Chappaqua, NY (US)

(72) Inventors: Dong Wang, Ossining, NY (US); Hongqiang Zhai, Ossining, NY (US); Monisha Ghosh, Chappaqua, NY (US)

(73) Assignee: KONINKLIJKE PHILIPS ELECTRONICS N.V., EINDHOVEN (NL)

(21) Appl. No.: 13/636,184

(22) PCT Filed: Mar. 15, 2011
(86) PCT No.: PCT/IB11/51080

§ 371 Date: Sep. 20, 2012

Related U.S. Application Data
(60) Provisional application No. 61/321,164, filed on Apr. 6, 2010.

(51) Int. Cl. H04W 72/08

(52) U.S. Cl. 455/41.2

(57) ABSTRACT

A centralized frequency agility technique is employed in conjunction with a plurality of medical body area network (MBAN) systems (10, 35, 36), each of which comprises a plurality of network nodes (12, 14) intercommunicating via short range wireless communication. A central network (20, 22, 23, 24) communicates with the MBAN systems via longer range communication that is different from the short range wireless communication. A central frequency agility sub-system (40) is configured to communicate with the MBAN systems. The central frequency agility sub-system receives current channel quality information for a plurality of available channels for the short range wireless communication, and allocates the MBAN systems amongst the available channels based at least on the received current channel quality information.

The following relates to the medical monitoring arts and related arts.

A medical body area network (MBAN) replaces the tangle of cables tethering hospital patients to their bedside monitoring units with wireless connections. This provides low-cost wireless patient monitoring (PM) without the inconvenience and safety hazards posed by wired connections, which can trip medical personnel or can become detached so as to lose medical data. In the MBAN approach, multiple low cost sensors are attached at different locations on or around a patient, and these sensors take readings of patient physiological information such as patient temperature, pulse, blood glucose level, electrocardiographic (ECG) data, or so forth. The sensors are coordinated by at least one proximate hub or gateway device to form the MBAN. The hub or gateway device communicates with the sensors using embedded short-range wireless communication radios, for example conforming with an IEEE 802.15.4 (Zigbee) short-range wireless communication protocol. Information collected by the sensors is transmitted to the hub or gateway device through the short-range wireless communication of the MBAN, thus eliminating the need for cables. The hub or gateway device communicates the collected patient data to a central patient monitoring (PM) station via a wired or wireless longer-range link for centralized processing, display and storage. The longer-range network may, for example, include wired Ethernet and/or a wireless protocol such as Wi-Fi or some proprietary wireless network protocol. The PM station may, for example, include an electronic patient record database, display devices located at a nurse's station or elsewhere in the medical facility, or so forth.

MBAN monitoring acquires patient physiological parameters. Depending upon the type of parameter and the state of the patient, the acquired data may range from important (for example, in the case of monitoring of a healthy patient undergoing a fitness regimen) to life-critical (for example, in the case of a critically ill patient in an intensive care unit). In general, there is a strict reliability requirement on the MBAN wireless links due to the medical content of the data.

Short-range wireless communication networks, such as MBAN systems, tend to be susceptible to interference. The spatially distributed nature and typically ad hoc formation of short-range networks can lead to substantial spatial overlap of different short range networks. The number of short-range communication channels allocated for short range communication systems is also typically restricted by government regulation, network type, or other factors. The combination of overlapping short-range networks and limited spectral space (or number of channels) can result in collisions between transmissions of different short range networks. These networks can also be susceptible to radio frequency interference (RFI) from other sources, including sources that are not similar to short-range network systems.

It is known to employ frequency agility mechanisms to mitigate RFI in short range networks. For example, in IEEE 802.15.4 (Zigbee) systems clear channel assessment (CCA) may be employed to identify a clear channel for communication and to avoid communicating on a busy channel or on a channel that is susceptible to RFI from other sources. In the Bluetooth™ system, random frequency hopping is used to mitigate the possible interference from other co-existing networks. Other approaches include direct sequence spectrum spreading (DSSS) and listen-before-talk protocols. A complementary approach is to perform error checking of the communicated data, for example employing checksum testing or so forth. If the communicated data fails the error checking it can be re-transmitted to ensure accuracy.

These techniques are generally effective for short range communication network applications which can tolerate some error and/or transmission delay. Different MBAN systems, depending on their applications, usually have different tolerance to transmission errors and delay. MBAN systems for fitness or wellbeing applications usually are able to tolerate such transmission errors and delay. However, MBAN systems for high-acuity monitoring usually carry life-critical medical data and thus have little or no error tolerance, and also are not amenable to transmission delays such as may be introduced by re-transmission. Transmission delays are problematic for such MBAN systems because delays in communication of life-critical data can delay detection of the onset of a life-threatening condition. Moreover, the sensor nodes of an MBAN system are preferably small (for patient comfort) and of minimal complexity (to enhance reliability and reduce manufacturing cost). The sensor nodes therefore typically have limited on-board data buffering, and so a continuously monitored life-critical parameter such as ECG data must be expeditiously transmitted off the sensor node to avoid losing the data.

The following provides new and improved apparatuses and methods which overcome the above-referenced problems and others.

In accordance with one disclosed aspect, a medical system comprises: a plurality of medical body area network (MBAN) systems, each MBAN system comprising a plurality of network nodes intercommunicating via short range wireless communication; a central network communicating with the MBAN systems via longer range communication that is different from the short range wireless communication; and a central frequency agility sub-system configured to communicate with the MBAN systems, the central frequency agility sub-system receiving current channel quality information for a plurality of available channels for the short range wireless communication and allocating the MBAN systems amongst the available channels based at least on the received channel quality information.

In accordance with another disclosed aspect, a method comprises: collecting current channel quality information for a plurality of channels usable by a plurality of medical body area network (MBAN) systems for short range communication amongst network nodes of the MBAN systems; and allocating the MBAN systems amongst the channels based at least on the collected current channel quality information.

One advantage resides in safe co-existence of multiple MBAN systems which may overlap in space.

Another advantage resides in reduced or eliminated likelihood of transmission delays within or from an MBAN system.

Another advantage resides in reduced or eliminated likelihood of loss of critical medical data acquired by an MBAN system.

Another advantage resides in principled allocation of short-range communication channels of varying quality to MBAN systems in accordance with the criticality of data acquired by the various MBAN systems.

Further advantages will be apparent to those of ordinary skill in the art upon reading and understanding the following detailed description.

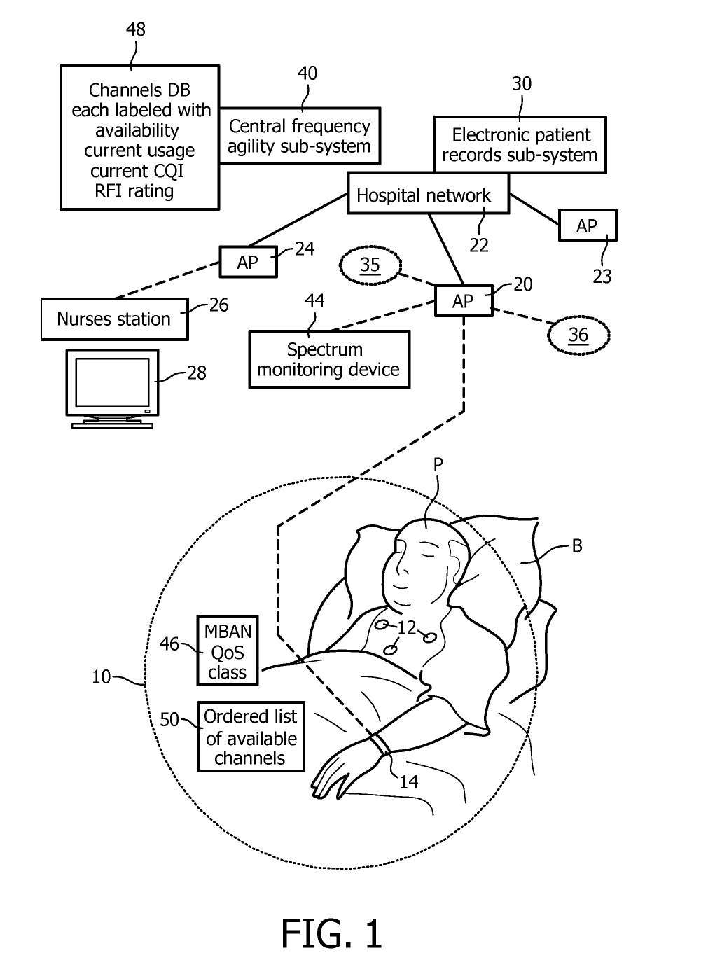

FIG. 1 diagrammatically illustrates a medical body area network (MBAN) system in the context of a medical environment including a central frequency agility sub-system as disclosed herein.

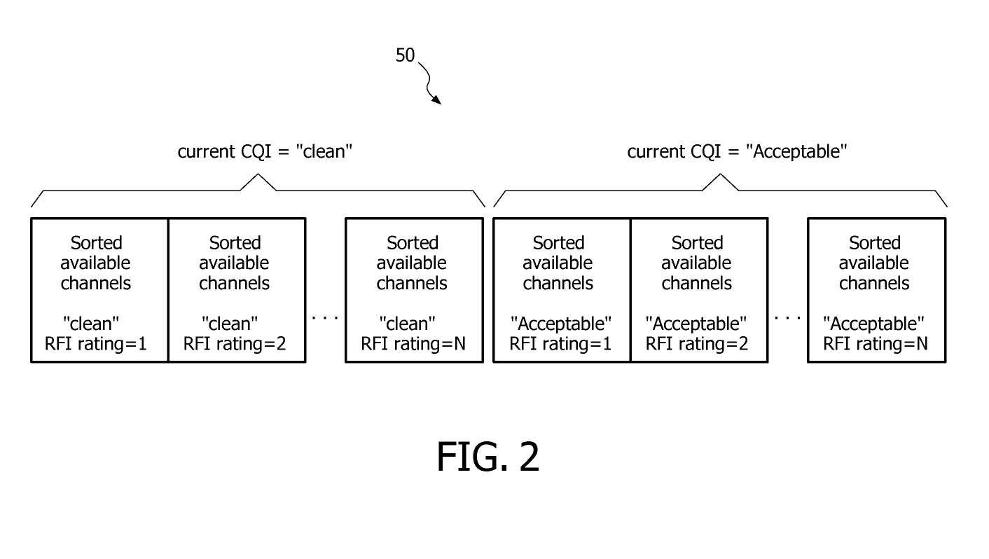

FIG. 2 diagrammatically illustrates an ordered list of available channels suitably generated by the central frequency agility sub-system of FIG. 1.

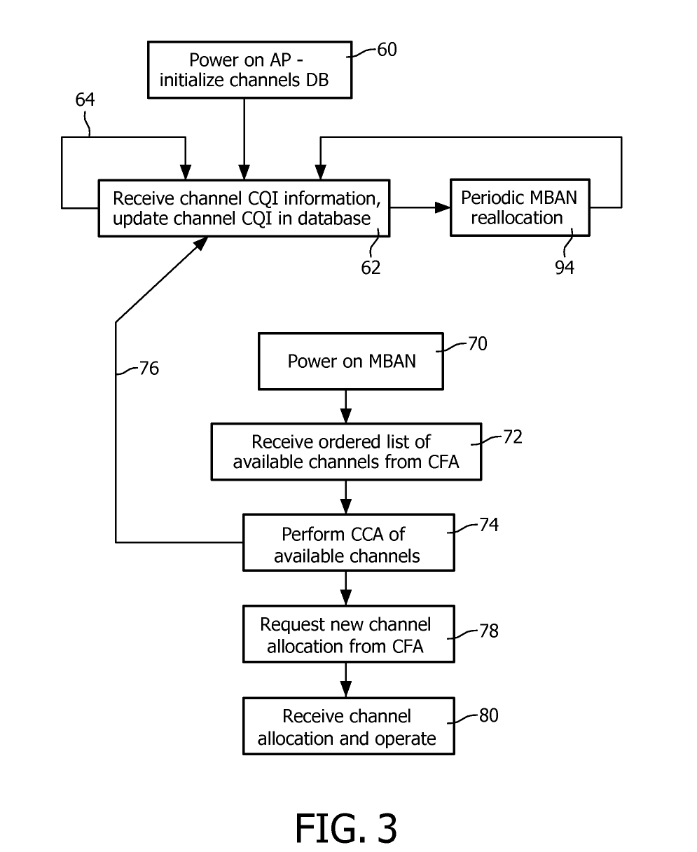

FIG. 3 diagrammatically illustrates initial processing flow in the central frequency agility sub-system of FIG. 1 and in the MBAN system of FIG. 1 as these systems are initialized.

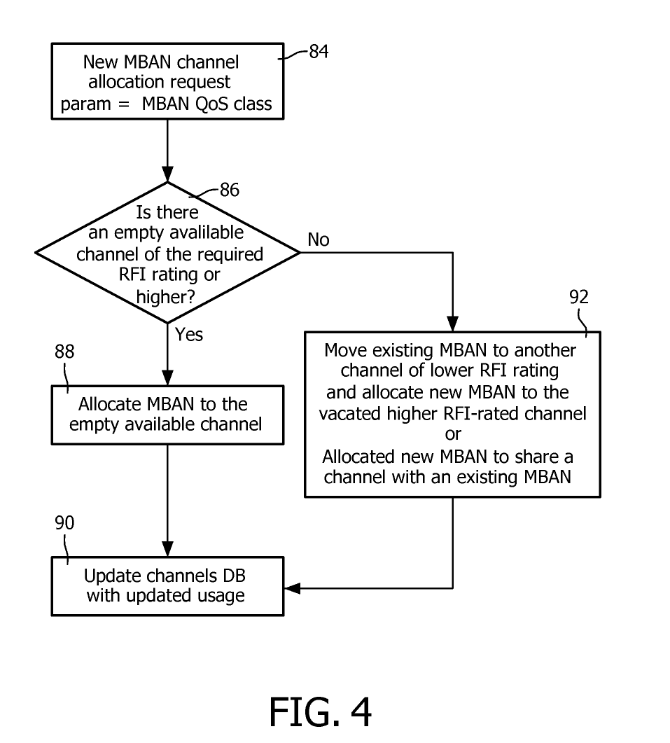

FIG. 4 diagrammatically illustrates processing flow in the central frequency agility sub-system of FIG. 1 responsive to a request for allocation of a communication channel for a new MBAN system.

With reference to FIG. 1, a medical body area network (MBAN) 10 includes a plurality of network nodes 12, 14. At least one of the network nodes 12, 14 serves as a hub device 14. The network nodes 12 communicate with the hub device 14 via a short-range wireless communication protocol. The MBAN 10 is also sometimes referred to in the relevant literature by other equivalent terms, such as a body area network (BAN), a body sensor network (BSN), a personal area network (PAN), a mobile ad hoc network (MANET), or so forth—the term medical body area network (MBAN) 10 is to be understood as encompassing these various alternative terms.

The illustrative MBAN 10 includes four illustrative network nodes 12, 14 including the hub device 14; however, the number of network nodes can be one, two, three, four, five, six, or more, and moreover the number of network nodes may in some embodiments increase or decrease in an ad hoc fashion as sensor nodes are added or removed from the network to add or remove medical monitoring capability. The network nodes 12 are typically sensor nodes that acquire physiological parameters such as heart rate, respiration rate, electrocardiographic (ECG) data, or so forth; however, it is also contemplated for one or more of the network nodes to perform other functions such as controlled delivery of a therapeutic drug via a skin patch or intravenous connection, performing cardiac pacemaking functionality, or so forth. A single network node may perform one or more functions. The illustrative network nodes 12 are disposed on the exterior of an associated patient P; however, more generally the network nodes may be disposed on the patient, or in the patient (for example, a network node may take the form of an implanted device), or proximate to the patient within the communication range of the short-range communication protocol (for example, a network node may take the form of a device mounted on an intravenous infusion pump (not shown) mounted on a pole that is kept near the patient, and in this case the monitored patient data may include information such as the intravenous fluid flow rate). It is sometimes desirable for the network nodes to be made as small as practicable to promote patient comfort, and to be of low complexity to enhance reliability—accordingly, such network nodes 12 are typically low-power devices (to keep the battery or other electrical power supply small) and may have limited on-board data storage or data buffering. As a consequence, the network nodes 12 should be in continuous or nearly continuous short-range wireless communication with the hub device 14 in order to expeditiously convey acquired patient data to the hub device 14 without overflowing the data buffer.

The hub device 14 (also sometimes referred to in the relevant literature by other equivalent terms, such as “gateway device” or “hub node”) coordinates operation of the MBAN 10 by collecting (via the Zigbee, Bluetooth™, or other short-range wireless communication protocol) patient data acquired by the sensors of the network nodes 12 and transmitting the collected data away from the MBAN 10 via a longer range communication protocol. The short-range wireless communication protocol preferably has a relatively short operational range of a few tens of meters, a few meters, or less, and in some embodiments suitably employs an IEEE 802.15.4 (Zigbee) short-range wireless communication protocol or a variant thereof, or a Bluetooth™ short-range wireless communication protocol or a variant thereof. Both Bluetooth™ and Zigbee operate in a frequency spectrum of around 2.4-2.5 GHz. Although Bluetooth™ and Zigbee are suitable embodiments for the short-range wireless communication, other short-range communication protocols, including proprietary communication protocols, are also contemplated. Moreover, the short-range wireless communication can operate at other frequencies besides the 2.4-2.5 GHz range, such as ranges in the hundreds of megahertz, gigahertz, tens-of-gigahertz, or other ranges. The short-range communication protocol should have a sufficient range for the hub device 14 to communicate reliably with all network nodes 12 of the MBAN system 10. In FIG. 1, this short-range wireless communication range is diagrammatically indicated by the dotted oval used to delineate the MBAN system 10. The short-range wireless communication is typically two-way, so that the network nodes 12 can communicate information (e.g., patient data, network node status, or so forth) to the hub device 14; and the hub device 14 can communicate information (e.g., commands, control data in the case of a therapeutic network node, or so forth) to the network nodes 12. The illustrative hub device 14 is a wrist-mounted device; however, the hub device can be otherwise mounted to the patient, for example as a necklace device, adhesively glued device, or so forth. It is also contemplated for the hub device to be mounted elsewhere proximate to the patent, such as being integrated with an intravenous infusion pump (not shown) mounted on a pole that is kept near the patient.

The hub device 14 also includes a transceiver (not shown) providing the longer-range communication capability to communicate data off the MBAN system 10. In the illustrative example of FIG. 1, the hub device 14 wirelessly communicates with an access point (AP) 20 of a hospital network 22. The illustrative AP 20 is a wireless access point that communicates wirelessly with the hub device 14. In the illustrative embodiment the hospital network 22 also includes additional access points, such as illustrative access points AP 23 and AP 24, that are distributed throughout the hospital or other medical facility. To provide further illustration, a nurses' station 26 is diagrammatically indicated, which is in wireless communication with the AP 24 and includes a display monitor 28 that may, for example, be used to display medical data for the patient P that are acquired by the MBAN system 10 and communicated to the nurses' station 26 via the path comprising the AP 20, the hospital network 22, and the AP 24. By way of another illustrative example, the hospital network 22 may provide access with an electronic patient records sub-system 30 in which is stored medical data for the patient P that are acquired by the MBAN system 10 and communicated to the electronic patient records sub-system 30 via the path comprising the AP 20 and the hospital network 22. The illustrative longer-range communication between the hub device 14 and the AP 20 is wireless, as diagrammatically indicated in FIG. 1 by a dashed connecting line. (Similarly, wireless communication between the AP 24 and the nurses' station 26 is indicated by a dashed connecting line). In some suitable embodiments, the longer-range wireless communication is suitably a WiFi communication link conforming with an IEEE 802.11 wireless communication protocol or a variant thereof. However, other wireless communication protocols can be used for the longer-range communication, such as another type of wireless medical telemetry system (WMTS). Moreover, the longer range communication can be a wired communication such as a wired Ethernet link (in which case the hub device includes at least one cable providing the wired longer range communication link)

The longer range communication is longer range as compared with the short-range communication between the network nodes 12 and the hub device 14. For example, while the short-range communication range may be of order a few tens of centimeters, a few meters, or at most perhaps a few tens of meters, the longer range communication typically encompasses a substantial portion of the hospital or other medical facility through the use of multiple access points 20, 23, 24 or, equivalently, multiple Ethernet jacks distributed throughout the hospital, in the case of a wired longer-range communication.

The longer-range communication, if wireless, requires more power than the short-range communication—accordingly, the hub device 14 includes a battery or other power source sufficient to operate the longer-range communication transceiver. Alternatively, the hub device 14 may include a wired electrical power connection. The hub device 14 also typically includes sufficient on-board storage so that it can buffer a substantial amount of patient data in the event that communication with the AP 20 is interrupted for some time interval. In the illustrative case of wireless longer-range communication, it is also to be understood that if the patient P moves out of range of the AP 20 and into range of another AP (for example, AP 23 or AP 24) then the IEEE 802.11 or other wireless communication protocol employed by the hospital network 22 (including its wireless access points 20, 23, 24) provides for the wireless link to shift from AP 20 to the newly proximate AP. In this regard, although the patient P is illustrated as lying in a bed B, more generally it is contemplated for the patient P to be ambulatory and to variously move into and out of range of the various access points 20, 23, 24. As the patient P thus moves, the MBAN 10 including the network nodes 12 and the hub device 14 moves together with the patient P.

In the MBAN 10, the network nodes 12 communicate with the hub device 14 via the short-range wireless communication. However, it is also contemplated for various pairs or groups of the network nodes 12 to also intercommunicate directly (that is, without using the hub device 14 as an intermediary) via the short-range wireless communication. This may be useful, for example, to coordinate the activities of two or more network nodes in time. Moreover, the hub device 14 may provide additional functionality—for example, the hub device 14 may also be a network node that includes one or more sensors for measuring physiological parameters. Still further, while the single hub device 14 is illustrated, it is contemplated for the coordinating functionality (e.g. data collection from from the network nodes 12 and offloading of the collected data via the longer range wireless communication) to be embodied by two or more network nodes that cooperatively perform the coordinating tasks.

In illustrative FIG. 1, only the single MBAN system 10 is illustrated in detail. However, it will be appreciated that more generally the hospital or other medical facility includes a plurality of patients, each having his or her own MBAN system. This is diagrammatically shown in FIG. 1 by two additional MBAN systems 35, 36 also communicating with the AP 20 via the longer range wireless communication. More generally, the number of MBAN systems may be, by way of some illustrative examples: two, three, four, five, ten, twenty, or more. Indeed, it is even contemplated for a single patient to have two or more different, independently operating MBAN systems (not illustrated). In this environment, various MBAN systems can be expected to occasionally come into close proximity with one another, such that the ranges of the respective MBAN system short-range wireless communications overlap.

Moreover, the hospital or other medical facility typically has numerous sources of radio frequency interference (RFI), such as magnetic resonance (MR) imaging scanners, computed tomography (CT) systems, radiation therapy systems, wireless radios in cellular phones and computers, radio equipment for communicating with ambulances, emergency response helicopters, local police, fire, or other rescue workers, and so forth. As a consequence, the various MBAN systems should be allocated channels for their respective short-range communication in a way that substantially avoids non-MBAN RFI and in a way that substantially avoids interference between proximate MBAN systems.

It is disclosed herein to employ a central frequency agility (CFA) sub-system 40 for this purpose of assigning short-range communication channels to the MBAN systems in a way that substantially avoids non-MBAN RFI and in a way that substantially avoids interference between proximate MBAN systems. The CFA sub-system 40 does not employ distributed frequency agility techniques as is commonly the case for Zigbee, Bluetooth™, or other ad hoc short-range wireless communication networks, but rather centralizes the frequency agility processing. The centralized approach disclosed herein takes advantage of the existence of the centralized longer-range communication network 20, 22, 23, 24 which is available in the hospital or other medical facility and with which the MBAN systems are configured to communicate. By employing the centralized CFA sub-system 40 to implement frequency agility, it is possible to provide principled allocation of short-range communication channels of varying quality to MBAN systems in accordance with the criticality of data acquired by the various MBAN systems. For example, although all MBAN systems are expected to collect important medical data, some MBAN systems may collect life-critical medical data (or, as another example, may deliver life-sustaining therapeutic intervention); whereas, other MBAN systems may collect medical data from healthy patients who are undergoing wellness treatment such as a fitness regimen. By centralizing the frequency agility, it is possible to allocate those MBAN systems engaged in life-critical operations to the cleanest channels (in the sense of potential for RFI interference and current channel quality information), and to allocate less critical MBAN systems to lower-grade (but still acceptable) channels.

The CFA sub-system 40 operates over an area within which MBAN systems may reasonably be expected to interfere with one another and/or experience common non-MBAN RFI. For large medical facilities, such as a multifloor hospital, more than one CFA sub-system may be provided, with the CFA sub-systems distributed over the medical facility in order to provide frequency agility for the various regions of the facility. In one suitable approach, each AP 20, 23, 24 is provided with its own CFA sub-system—by way of illustrative example, the CFA sub-system 40 of FIG. 1 is assumed to be associated with the AP 20 and to perform frequency agility for the MBAN systems 10, 35, 36 and for any other MBAN systems that communicate with the AP 20. In such embodiments, the CFA sub-system 40 may be embodied by the processor of the AP 20 executing suitable software to implement the CFA sub-system 40. Alternatively, the CFA sub-system 40 may be embodied by another processor communicating with the AP 20 via the hospital network 22. Moreover, a single CFA sub-system may perform centralized frequency agility for MBAN systems communicating with two or more access points, or for other suitable groupings of the MBAN systems.

The CFA sub-system 40 receives as input current channel quality information (CQI) for the channels that are usable for the MBAN system short-range wireless communications. The current CQI information may be collected from various sources. In some embodiments, the MBAN systems 10, 35, 36 perform clear channel assessment (CCA) to generate the current CQI information. Additionally or alternatively, a dedicated spectrum monitoring device 44 (or a spatial distribution of such devices) may be provided to acquire the CQI information. The spectrum monitoring device 44 or devices are optionally AC powered so that they do not have batteries to be replaced or recharged. The CCA is suitably performed by energy detection (ED) or carrier sensing or other suitable CCA operations to generate in-band interference information for the channels. The CQI information may also include MBAN packet detection (for example, using a high-gain antenna) to acquire information about current activity on the channels, including estimation of transmission duty cycles. The CQI information may also include analysis of potential in-band interference to assess interference sources (e.g., 802.15.4, 802.11b/g, Bluetooth™, or so forth). The CQI information acquired by the MBAN systems 10, 35, 36 and/or the spectrum monitoring device 44 or devices are communicated to the CFA sub-system 40 via the longer range communication, so that the CQI information can be centrally collected at the CFA sub-system 40.

The CFA sub-system 40 allocates the MBAN systems 10, 35, 36 amongst the available channels based at least on the received current CQI information. The allocation may also be based on other information, such as an RFI rating for each channel which indicates the likelihood of experiencing non-MBAN interference on that channel, and a quality of service (QoS) classification for the MBAN systems 10, 35, 36. The latter information, if available, is used to bias the allocations toward assigning channels with better current CQI (and, optionally, RFI ratings indicative of lower likelihood of RFI) to MBAN systems having higher QoS classifications.

For example, in an illustrative MBAN QoS classification scheme, there are M classifications, with the highest QoS class (i.e., Class 1) being reserved for MBAN systems engaged in life-critical applications, and the lowest QoS class (i.e., Class M) used for non-critical applications such as fitness monitoring. The QoS class of an MBAN system can be assigned by a physician, nurse, or other medical personnel when the MBAN system is created. Additionally or alternatively, the QoS class of an MBAN system can be assigned automatically based on the application running on the MBAN system. In the latter case, the MBAN system is suitably assigned its class based on the most critical application being performed by the MBAN system. To diagrammatically illustrate, FIG. 1 diagrammatically shows an MBAN QoS class 46 assigned to the MBAN system 10. (It is to be understood that the other MBAN systems 35, 36 each also have an assigned MBAN QoS class).

The channels are also optionally assigned RFI ratings. These ratings are distinct from the current CQI for the channel because the RFI rating is not based on current measurements or on MBAN usage, but rather is based on the likelihood of non-MBAN RFI occurring on the channel. For example, in one suitable RFI rating scheme, there are 1, . . . , N RFI rating levels with RFI rating Level 1 assigned to channels with the lowest likelihood of non-MBAN RFI and Level N assigned to channels with the highest likelihood of non-MBAN RFI. As a more specific example, the inner M-band channels, which are reserved specially for MBAN applications and are expected to have the smallest non-MBAN RFI, may be assigned RFI Level 1. Conversely, RFI Level N is for the MBAN channels that have the highest probability of being interfered by other wireless systems, and may for example include ISM channels that overlap with the ISM 2.4 GHz Wi-Fi channel. In some embodiments, the MBAN RFI ratings are predefined and stored in a database accessible by the CFA sub-system 40.

In the illustrative embodiment, the CFA sub-system 40 maintains a channels database 48 that lists, for each channel, its availability, its current usage (i.e., which MBAN systems are assigned to the channel and, at least in the case of shared channels, their duty cycles), the current CQI for the channel, and the channel RFI rating. The availability of a channel indicates whether the channel can be used by MBAN systems. A channel may be listed as unavailable for various reasons: its current CQI may be so poor that it cannot be used by MBAN systems; or the channel may be available for MBAN usage on a secondary basis and is currently in use by a primary non-MBAN user; or so forth. The channels database 48 can have various formats and can store various channel information in various ways. As an illustrative embodiment, the following table structure can be used:

```
Table {
  Field: channel_number,
    the MBAN channel number
  Field: channel_rating
    the channel RFI rating
  Field: channel_status:
    ‘Idle’ if no MBAN uses this channel, otherwise ‘busy’
  Field: active_MBAN_list
    This field is empty if channel_status is ‘idle’, otherwise it is a
    sub-table, which includes the information of active MBANs
    on the channel
    Sub-table {
      Field: MBAN_id,
        The MBAN id number
      Field: MBAN_QoS_class
      Field: Duty_cycle
        The aggregated duty cycle of this MBAN
      Field: Relative_timing
        The relative timing to the AP device. This
        field is optional when a superframe
        structure is used for MBANs and
        inter-MBAN synchronization is
        utilized to improve the channel
        usage efficiency.
        }
  }
```

With continuing reference to FIG. 1 and with further reference to FIG. 2, to facilitate efficient operation of the MBAN systems 10, 35, 36, in some embodiments an abridged copy of the channels database 48 is constructed by the CFA sub-system 40 and is communicated to the MBAN systems. In illustrative FIG. 1, this is diagrammatically illustrated by an ordered list 50 of available channels that has been communicated to and is stored at the MBAN system 10. (It is understood that copies of the ordered list 50 are also stored at each of the other MBAN systems 35, 36). FIG. 2 diagrammatically shows the ordered list 50 in greater detail. The ordered list 50 of channels is sorted at least on the current CQI of the channel, and in the illustrative embodiment the ordered list 50 is secondarily sorted on the RFI rating of the channel. The ordered list 50 includes only those channels that are available for use in MBAN systems of at least one MBAN class. In the illustrative example: channel CQI class “Clean” is usable for MBAN systems of the highest MBAN Class 1 (e.g., life-critical applications) and are listed first in the ordered list 50; channel CQI class “Acceptable” is usable for all MBAN systems except MBAN class 1, and is listed next in the ordered list 50; and finally channel CQI class “Poor” is deemed unusable for any MBAN system of any type, and accordingly is not included in the ordered list 50. The channels database 48 is updated and the ordered list 50 updated and resent to the MBAN systems 10, 35, 36 on a regular basis.

One approach for constructing the ordered list 50 is as follows. The input parameters include the measured channel CQI (in terms of non-MBAN-interference-plus-noise power) for all usable channels (including channels that may be listed as unavailable in the database 48). The channel CQI is determined based on the channel quality information measured by the MBAN systems 10, 35, 36 and/or by the optional dedicated spectrum monitoring device(s) 44. The input parameters also optionally include the radio frequency spectrum used by current active non-MBAN wireless networks. This information could come from a database (not shown) accessible by the CFA sub-system 40, for example via the hospital network 22. Such a database may, for example, include empirical measurement data and/or information based on rated spectral RFI of electronic devices in the hospital. This information may also be embodied in the RFI ratings of the channels—for example, if a hospital MRI system is known to generate strong RFI at a particular channel, that channel may be given an RFI rating reflecting the expected high likelihood of experiencing RFI from the hospital MRI system. Another optional input is the RF spectrum to be protected. For example, if a band is allocated on a secondary basis and there are some primary users active in that band, then the current used RF spectrum by active primary users should not be allocated to any of the MBAN systems. This information may be generated by the CCA together with knowledge of the secondary allocation status of the channel for MBAN systems. The sorting algorithm is then suitably as follows. First, all the channels in the RF spectrum to be protected should be omitted from the ordered list 50. (This suitably avoids having MBAN systems use spectrum currently used by primary users). Second, group the channels by RFI rating i, i=1 to N. For the channels of each RFI rating, group the channels into three CQI groups: ‘clean’, ‘acceptable’, and ‘dirty’. One way to do this is that if the non-MBAN-interference-plus-noise power is greater than a “dirty” threshold then label the channel as having a ‘dirty’ current CQI; else if the non-MBAN-interference-plus-noise power is less than a “clean” threshold (and the channel is not in the RF spectrum used by the current active non-MBAN wireless networks) then label it as ‘clean’; else label it as ‘acceptable’. Any channels that are labeled with a ‘dirty’ channel CQI are considered unavailable for allocation to MBAN networks and accordingly are omitted from the ordered list 50. Finally, the remaining channels having channel CQI ‘clean’ or ‘acceptable’ are sorted based on the non-MBAN-interference-plus-noise power in an ascending order, and the results are combined to build up the ordered available channel list 50 as shown in FIG. 2.

The ordered list 50 of available channels can be used in various ways by the MBAN system 10. For example, in performing the CCA the MBAN system 10 optionally collects CQI information for only those channels listed in the ordered list 50. This approach enhances efficiency by avoiding performing CCA on channels that are unavailable. As another application, in the event of RFI interference or collision on the currently allocated channel, the MBAN system 10 can refer to the ordered list 50 to identify a suitable ‘clean’ (or ‘acceptable’, in the case of MBAN QoS class 46 being non-life-critical) channel to which the MBAN system 50 can switch so as to avoid the RFI or collision. This local reallocation decision is then forwarded to the CFA sub-system 40 for entry in the channels database 48. If the local reallocation decision is determined to be unacceptable by the CFA sub-system 40, it can take suitable remedial action.

Having disclosed suitable embodiments of the centralized frequency agility system with reference to FIGS. 1 and 2, some further operational aspects are set forth with further reference to the flowcharts of FIGS. 3 and 4.

With reference to FIGS. 1 and 3, startup procedures for initially powering up the AP 20 and the MBAN 10 are set forth. When the AP 20 is powered on, its CFA sub-system 40 and associated channels database 48 are initialized in an operation 60. The ordered list of available channels 50 is also suitably generated is based on predefined channel RFI ratings. The channel usage status table is initialized by setting all the available channels as ‘IDLE’. In an operation 62, channel CQI information conveyed to the AP 20 from the MBAN systems 10, 35, 36 and/or the monitoring device(s) 44 via the longer range communication are used to initialize or update the channel CQI values in the channels database 48, and the cumulative information in the channels database 48 is used to allocate MBAN systems to available channels having channel CQI compatible with the MBAN QoS classes. The operation 62 is updated as additional channel CQI information is received, as indicated by the loop 64.

The operation 62 is performed in conjunction with CCA or other CQI information acquisition performed by the MBAN systems 10, 35, 36 and/or the monitoring device(s) 44, as diagrammatically shown for the illustrative MBAN system 10. In FIG. 3, the MBAN 10 powers up in an operation 70 and receives the ordered list 50 of channels via the longer range communication in an operation 72. The MBAN system 10 then performs CCA or other channel CQI information acquisition in an operation 74, and the CQI information is conveyed to the CFA sub-system 40 via the longer range communication for use in the operation 62 as diagrammatically indicated in FIG. 3 by connecting arrow 76. In an operation 78 the MBAN system 10 sends a request for new channel allocation to the CFA sub-system 40 via the longer range communication, and in an operation 80 the MBAN system 10 receives the new channel allocation from the CFA sub-system 40, again via the longer range communication, and begins MBAN operation.

With continuing reference to FIGS. 1 and 3 and with further reference to FIG. 4, the operation 78 generates a new MBAN channel allocation request 84 that is processed by the CFA sub-system 40 as shown in FIG. 4. The new MBAN channel allocation request 84 has an associated MBAN class parameter indicating the MBAN QoS class 46 of the MBAN 10 for which the new channel is to be allocated. In an operation 86, the CFA sub-system 40 searches the channels database 48 for an empty available channel. In this context, ‘empty’ means the channel status information in the usage status table is ‘Idle’ and also the CCA 74 performed by the MBAN 10 also showed the channel to be ‘idle’. If the operation 86 identifies an empty available channel, then the CFA sub-system 40 allocates the MBAN 10 to that channel in an operation 88, and sends the channel allocation response to the hub device 14 of the MBAN 10 with the selected empty channel number. The MBAN 10 begins operations at the allocated channel (this corresponds to the receipt-and-operate operation 80 performed at the MBAN 10), and the MBAN 10 optionally sends back a channel assignment confirmation to CFA sub-system 40. The CFA sub-system 40 updates the channel database 48 with the new channel assignment in an operation 90. On the other hand, if there is no ‘empty’ channel available, then the CFA sub-system 40 performs an operation 92 in which it searches for a ‘busy’ channel in the channel database 48 that is in use by an existing MBAN system having a lower QoS class than the new MBAN system 10. If such a ‘busy’ channel is found, the CFA sub-system 40 sends commands to the MBAN system operating on that ‘busy channel and reallocates them to other channels of lower (but still acceptable) channel CQI, and the CFA sub-system 40 allocated the MBAN system 10 to the vacated channel and follows up with the database update of operation 90. The ‘other channel’ to which the pre-existing MBAN system of lower MBAN QoS class is reallocated could be a ‘busy’ channel already in use by one or more other MBAN systems, so long as the sum of their aggregated duty cycles is lower than some threshold so as to guarantee that there is no significant collision probability increase caused by the reallocation. In the extreme case that there are too many MBAN systems crowded together, the CFA sub-system 40 can generate a warning message to system administrators.

When an active MBAN system moves into the service area of the AP 20, it will handover and connect to the AP 20. This MBAN system suitably continues to work on its current short-range wireless communication channel, but also reports its current channel allocation, its MBAN QoS class, and its aggregated duty cycle to the CFA sub-system 40 of the AP 20. The CFA sub-system 40 determines whether the new MBAN system operating on its current channel could cause potential collision increase in that channel. If no, then the CFA sub-system 40 updates the channels database 48 to reflect usage of the channel by the newly entrant MBAN system. On the other hand, if the collision probability is increased, the channel has an RFI rating indicative of a high likelihood of RFI, or is otherwise not acceptable, then the CFA sub-system 40 performs the process of FIG. 4 to allocate a new channel to the newly entrant MBAN system.

If an MBAN system detects channel quality degradation and cannot work properly, for example due to non-MBAN RFI or collision with short-range wireless communication of a nearby MBAN system on the same channel, then the MBAN system suitably makes a local channel reallocation so as to switch to a new channel. This local channel reallocation is suitably based on the CCA performed by the MBAN system and based on the copy of the ordered list of available channels 50 stored at the MBAN system. Such local channel reallocation ensures that an MBAN system can quickly switch to a new channel, and can thereby avoid loss of potentially critical medical data. However, the local channel reallocation is provisional. The MBAN system reports the local channel reallocation to the CFA sub-system 40, which determines whether the local channel reallocation is acceptable based on the information contained in the centralized channels database 48. If the local channel reallocation is not acceptable, then the CFA sub-system 40 performs the process of FIG. 4 to allocate a new channel to the MBAN system, so as to effectively “overrule” the local channel reallocation.

With continuing reference to FIG. 1 and with further reference back to FIG. 3, the CFA sub-system 40 optionally performs a periodic MBAN system reallocation operation 94. This operation is performed is a centralized update of the MBAN system channel allocations, and can (by way of example) move the MBAN systems having the highest MBAN QoS class to the best quality channels (as measured by current channel CQI and channel RFI rating) and switch MBAN systems having lower MBAN QoS class(es) to other available channels of lower quality. The periodic reallocation operation 94 ensures that MBAN systems are optimally allocated amongst the available channels.

When an MBAN system moves out the serving area of the AP 20, or when an MBAN system served by the AP 20 is turned off, then the CFA sub-system 40 of the AP 20 suitably removes the channel usage information for that MBAN system from the channels database 48.

This application has described one or more preferred embodiments. Modifications and alterations may occur to others upon reading and understanding the preceding detailed description. It is intended that the application be construed as including all such modifications and alterations insofar as they come within the scope of the appended claims or the equivalents thereof.

1. A medical system comprising:
a plurality of medical body area network (MBAN) systems, each MBAN system comprising a plurality of network nodes intercommunicating via short-range wireless communication;
a central network communicating with the MBAN systems via longer range communication that is different from the short-range wireless communication; and
a central frequency agility sub-system configured to communicate with the MBAN systems, the central frequency agility sub-system receiving current channel quality information for a plurality of available channels for the short-range wireless communication and allocating the MBAN systems amongst the available channels based at least on the received current channel quality information.

2. The apparatus as set forth in claim 1, wherein each MBAN system includes a plurality of network nodes communicating with a hub device via short-range wireless communication, the hub device communicating with the central network via the longer range communication.

3. The apparatus as set forth in claim 1, wherein the central frequency agility sub-system allocates the MBAN systems amongst the available channels further based on (i) radio frequency interference ratings for the channels and (ii) quality of service classifications of the MBAN systems.

4. The apparatus as set forth in claim 3, wherein responsive to receiving a new channel allocation request from an unallocated MBAN system the central frequency agility sub-system performs a method comprising:
allocating the unallocated MBAN system to an available channel that is empty conditional on there being an empty available channel having a radio frequency interference rating compatible with a quality of service classification of the unallocated MBAN system, and
if there are no empty available channels having a radio frequency interference rating compatible with the quality of service classification of the unallocated MBAN system, then reallocating an already-operating MBAN system having a lower quality of service classification than the quality of service classification of the unallocated MBAN system to another channel and allocating the unallocated MBAN system to the channel vacated by the reallocating.

5. The apparatus as set forth in claim 3, wherein the central frequency agility sub-system assigns:
a radio frequency interference rating indicative of a relatively lower likelihood of radio frequency interference to channels exclusively assigned for MBAN system short-range wireless communication, and
a radio frequency interference rating indicative of a relatively higher likelihood of radio frequency interference to channels having shared assignment to both MBAN system short-range wireless communication and at least one type of non-MBAN short-range wireless communication.

6. The apparatus as set forth in claim 1, wherein the MBAN systems are configured to:
acquire current channel quality information for the plurality of available channels, and
send the acquired current channel quality information to the central frequency agility sub-system via the longer range communication.

7. The apparatus as set forth in claim 1, further comprising:
at least one spectrum monitoring device configured to:
acquire current channel quality information for the plurality of available channels, and
send the acquired current channel quality information to the central frequency agility sub-system via the longer range communication.

8. The apparatus as set forth in claim 1, wherein the central frequency agility sub-system is configured to:
construct an ordered list of available channels that is sorted at least on current channel quality information for the available channels, and
send the ordered list of available channels to the plurality of MBAN systems via the longer range communication.

9. The apparatus as set forth in claim 8, wherein the central frequency agility sub-system omits from the ordered list of available channels any channel that has current channel quality information indicating the current channel quality is too poor to be used by any MBAN system.

10. The apparatus as set forth in claim 8, wherein the central frequency agility sub-system omits from the ordered list of available channels any channel that is available to the MBAN systems on a secondary basis and is currently in use by a primary non-MBAN user.

11. The apparatus as set forth in claim 8, wherein the MBAN systems are configured to:
acquire current channel quality information for only the available channels listed in the ordered list of available channels, and
send the acquired current channel quality information to the central frequency agility sub-system via the longer range communication.

12. The apparatus as set forth in claim 8, wherein responsive to an MBAN system detecting radio frequency interference or a collision:
(i) the MBAN system allocates to itself a new channel selected from the ordered list of available channels wherein the selection of the new channel is based at least in part on the ordering of the ordered list,
(ii) the MBAN system communicates the new channel allocation to the central frequency agility sub-system, and
(iii) the central frequency agility sub-system accepts or overrides the new channel allocation.

13. The apparatus as set forth in claim 8, wherein the central frequency agility sub-system sorts the ordered list of available channels based current channel quality information for the available channels and based on radio frequency interference ratings for the channels.

14. The apparatus as set forth in claim 1, wherein:
the central network includes a longer range wireless communication implemented by a plurality of spatially distributed access points; and
the central frequency agility sub-system allocates the MBAN systems allocated to a common access point amongst the available channels.

15. The apparatus as set forth in claim 1, wherein the central frequency agility sub-system periodically repeats the allocating of the MBAN systems amongst the available channels based at least on the current channel quality information.

16. A method comprising:
collecting current channel quality information for a plurality of channels usable by a plurality of medical body area network (MBAN) systems for short-range communication amongst network nodes of the MBAN systems; and
allocating the MBAN systems amongst the channels based at least on the collected current channel quality information.

17. The method as set forth in claim 16, wherein the allocating is further based on quality of service classifications of the MBAN systems.

18. The method as set forth in claim 17, wherein the allocating comprises:
allocating an unallocated MBAN system to an empty channel if an empty channel having current channel quality information compatible with the quality of service classification of the unallocated MBAN is available; and
if no empty channel having current channel quality information compatible with the quality of service classification of the unallocated MBAN is available then:
reallocating an already-allocated MBAN system having a lower quality of service classification than the quality of service classification of the unallocated MBAN to a channel having a lower current quality of service, and
allocating the unallocated MBAN system to the channel vacated by the reallocating.

19. The method as set forth in claim 16, further comprising:
generating the current channel quality information that is collected by the collecting operation at the MBAN systems.

20. The method as set forth in claim 16, further comprising:
constructing an ordered list of available channels based at least on current channel quality information for the channels; and
communicating the ordered list of available channels to the MBAN systems, wherein the MBAN systems generate the current channel quality information that is collected by the collecting operation only for channels of the ordered list of available channels.

21. The method as set forth in claim 16, further comprising:
constructing an ordered list of available channels based at least on current channel quality information for the channels;
communicating the ordered list of available channels to the MBAN systems; and
performing a local channel reallocation at an MBAN system based on the communicated ordered list of available channels.
